(19) United States
(12) Patent Application Publication
(10) Pub. No.: US 2018/0077989 A1
(43) Pub. Date: Mar. 22, 2018

(54) Shock Mitigating Materials and Methods Utilizing Spiral Shaped Elements

(71) Applicant: Mississippi State University, Mississippi State, MS (US)

(72) Inventor: Mark F. Horstemeyer, Starkville, MS (US)

(73) Assignee: Mississippi State University, Mississippi State, MS (US)

(21) Appl. No.: 15/670,800

(22) Filed: Aug. 7, 2017

Related U.S. Application Data
(63) Continuation-in-part of application No. 13/469,172, filed on May 11, 2012, now Pat. No. 9,726,249.
Application No. 13/469,172 is a continuation-in-part of application No. 14/694,715, filed on Apr. 23, 2015, now Pat. No. 9,820,522.

(51) Int. Cl. A42B 3/06; A41D 13/015

(52) U.S. Cl. CPC A42B 3/063; F16F 7/00; A41D 13/015

(57) ABSTRACT

Various embodiments of a spiral shaped element and wavy suture are disclosed for use in a shock mitigating material to dissipate the energy associated with the impact of an object. The shock mitigating material can be used in helmets, bumpers, bulletproof vests, mats, pads, military armor, and other applications. One embodiment, among others, is a shock mitigating material having spiral shaped elements, each having a circular cross section and each being tapered from a large outside end to a small inside end but also having a suture or sutures that can induce shear waves to mitigate the shock pressure and impulse. Another embodiment is a shock mitigating material having sutures (wavy gaps or wavy materials). In this embodiment when the material is impacted, the wavy gap or material will induce a mechanism in shear to dissipate the impact energy.

### CLAIM OF PRIORITY

This application is a continuation-in-part of U.S. patent application Ser. No. 13/469,172, filed May 11, 2012, which claims priority to and the benefit of U.S. Provisional Patent Application No. 61/485,847, filed May 13, 2011, the entirety of both of which is incorporated herein by reference.

This application is a continuation-in-part of U.S. patent application Ser. No. 14/694,715, filed Apr. 23, 2015, which claims priority to and the benefit of U.S. Provisional Patent Application No. 61/983,133, filed Apr. 23, 2014, the entirely of both of which is incorporated herein by reference.

### STATEMENT OF GOVERNMENT SUPPORT

This invention was made with Government support under DE-EE0002323 awarded by the U.S. Department of Energy. The Government has certain rights in the invention.

### FIELD OF THE INVENTION

The present invention generally relates to shock mitigating materials and, more particularly, to materials that can be used in helmets, bumpers, bullet proof vests, military armor, pads, mats, and other applications to dissipate energy and action associated with an object impact.

### BACKGROUND OF THE INVENTION

American football can be a very dangerous sport for its players. Players continue to get bigger and stronger and the speed of play continues to increase. Players commonly suffer injures. In fact, currently the average career of a player in the National Football League (NFL) is just over four (4) years. Furthermore, head injuries are common. Current helmet designs are not adequately protecting the players. There is a need for improved football helmet designs that better protect players. However, impacts that induce injuries including brain injuries are not only related to sporting events like football, baseball, and hockey, but such impacts can occur from motorcycle, bicycle, and vehicle crashes and military strikes, for example.

### SUMMARY OF THE INVENTION

The present invention provides descriptions of various embodiments of a cantilevered spiral shaped element and cyclically designed waves in structures that can be used in a manufactured (man-made) shock mitigating material to dissipate the energy associated with the impact of an object, so that energy moving in the direction or transverse to the direction or any angle in between of the object impact is attenuated. The shock mitigating material can be used in helmets of virtually any kind, bumpers, bullet proof vests, military armor, body pads, floor or other types of mats, and many other applications. The shock mitigating material can be of any relevant size and can be of any shape, such as curved and/or planar, for example.

One embodiment of the present invention, among others, is shock mitigating material having one or more spiral shaped elements contained therein, each having a circular, polygonal, rectangular, triangular, or any combination of these as a cross section, and each being tapered from a large end to a small inside end, or vice versa. Furthermore, one of the ends is fixed, or mounted, while the other end is free, or unmounted, so that when the material is impacted by an object, the impact energy is converted into shear waves by the spiral elements as the free ends of the spiral elements vibrate. This dissipates impact energy and action (energy multiplied by time).

Another embodiment is a shock mitigating material having one or more sutures (wavy gaps or wavy materials). In this embodiment, when the material is impacted the suture will induce a mechanism in shear to dissipate the impact energy and action.

Another embodiment is a manufactured, shock mitigating, material layer that dissipates impact energy when physically impacted by an object. The material layer comprises first and second sections and a suture at a junction where the first and second sections meet. The suture has first and second edges associated respectively with the first and second sections. The first and second edges generally exhibit periodic waveforms. Each of the first and second edges are movable relative to each other so that the first and second edges are capable of transforming a substantial part of a longitudinal mechanical shock wave imposed upon the first and second edges into shear waves within the material layer when the material layer is impacted by the object in order to dissipate the impact energy and action.

Other embodiments, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the geometric effects of the present invention. Moreover, in the drawings, like reference numerals designate corresponding parts throughout the several views.

FIG. 1(a) is a schematic representation of the four finite element models used in the analysis to demonstrate the energy dissipating properties of spiral shaped elements.

FIG. 1(b) shows a suture within a structure in which the finite element model illustrates the wave dispersion effects from the suture.

FIG. 2 is a graph of ramped, pressure load history applied to a fixed end of each of the models of FIG. 1(a).

FIGS. 3(a) and 3(b) show displacement (a) contour and (b) wave propagation plots, respectively, of each of the models of FIG. 1(a).

FIGS. 4(a) and 4(b) show pressure (a) contour and (b) wave propagation plots, respectively, of each of the models of FIG. 1(a).

FIGS. 5(a) and 5(b) show Von Mises stress (a) contour and (b) wave propagation plots, respectively, of each of the models of FIG. 1(a).

FIGS. 6(a) and 6(b) show normalized free-end (a) pressure and (b) displacement response, respectively, of a cylinder, tapered cylinder, spiral, and tapered spiral. The lower abscissa specifies the time at which the longitudinal wave first reaches the free end. The reflected longitudinal wave arrives back at the fixed end and so on. Similarly, the upper abscissa corresponds to the time at which the shear wave reaches the free end.

FIGS. 7(a) and 7(b) show normalized (a) impulse and (b) displacement, respectively, at the free end of each model of FIGS. 6(a) and 6(b). Impulse is found by multiplication of the free-end pressure history by the respective free-end area of each geometry followed by integration of the resulting force history (where negative values are neglected). Free-end displacement is taken as the area under the free-end displacement history curve. The free-end impulse and displacement values of the cylinder are used to normalize the results.

FIG. 8 is a graph showing a normalized free-end transverse displacement response for the models of FIGS. 6(a) and 6(b).

FIG. 9 shows finite element simulation results of the pressure wave as it traversed down different blocks of material with the (a) straight line, (b) single wave embedded in the block of material with a straight edge, (c) single wave embedded in a block of material with an out-of-phase wavy structure, and (d) single wave embedded in a block of material with an in-phase wavy structure.

FIG. 10 shows the free-end transverse impulse from the different wave configurations embedded within the material.

FIG. 11 is a cross-sectional view of an embodiment of a football helmet having a plurality of material layers including a shock mitigating material layer having spiral shaped elements.

FIG. 12(a) is a partial enlarged view of a first embodiment of the plurality of layers of FIG. 11.

FIG. 12(b) is a partial enlarged view of a second embodiment of the plurality of layers of FIG. 11.

FIG. 13 is a partial enlarged view of a third embodiment of the plurality of layers for the helmet of FIG. 11.

FIG. 14 is a perspective view of a first embodiment of the spiral shaped elements of the shock mitigating material layer of FIG. 11 wherein the spiral shaped element is in a planar configuration.

FIG. 15 is a perspective view of a second alternative embodiment of the spiral shaped elements of the shock mitigating material layer of FIG. 11 wherein the spiral shaped element is in a helix configuration.

FIG. 16(a) is a perspective view of an embodiment of a material layer for a football helmet wherein the material layer has a plurality of sutures.

FIG. 16(b) is a perspective view of the embodiment of FIG. 16(a) but with sections separated in order to illustrate the sutures.

FIG. 16(c) is a rear view of the embodiment of FIG. 16(a).

FIG. 16(d) is a rear view of the embodiment of FIG. 16(a) but with the sections separated in order to illustrate the sutures.

### DETAILED DESCRIPTION OF THE PREFERRED EMBODIMENTS

The physics of stress waves, and all other wave types, are governed by three fundamental, conservation laws: conservation of mass, momentum, and energy. Neglecting surface waves, there are two main types of waves that propagate through elastic, isotropic solids: longitudinal waves and shear waves. Longitudinal waves (also called dilatational, pressure, primary, or P-waves) propagate with a characteristic wave speed and represent a volumetric change. Their motion is parallel to the direction of propagation of the wave. Shear waves (also called secondary, S-, or distortional waves) represent no volume change and propagate at a slower wave speed with respect to longitudinal waves. Their motion is normal to the direction of propagation. See, for example, Davis J. L., “Wave Propagation in Solids and Fluids,” New York, N.Y.: Spring-Verlag Inc., 1988; Zukas J. A., Nicholas T, Swift H. F., Greszczuk L B, Curran D. R., “Impact Dynamics,” Malabar, F. L., Krieger Publishing Co., 1992; and Achenbach J. D., “Wave propagation in elastic solids,” North-Holland, 1993, all of the foregoing publications of which are incorporated herein by reference in their entirety.

When either a longitudinal or shear wave impinges on a boundary, new waves are generated due to the reflective nature of waves. In a body with finite dimensions, these waves bounce back and forth between the bounding surfaces and interact with one another. These interactions can lead to wave amplification, cancellation, and other wave distortions. In the present invention described herein, both the spiral geometry and suture(s) introduce deleterious shear waves that disperse, attenuate, and dissipate the input pressure.

When the cross-sectional area of a cylindrical bar is reduced, a geometric impedance difference arises despite the intrinsic impedance of the material remaining unaltered.

When a compressive elastic wave produced by a dynamic load or impact reaches the free end (or unattached or unmounted end) of the bar, it reflects back from that surface as a tensile wave. This reflected tensile wave can have detrimental effects on the medium through which it travels.

Impulse is defined as the integral of a force with respect to time. The impulse is equal to the change in momentum of the body. It is possible for a very brief force to produce a larger impulse than a force acting over a much larger time period if that force is sufficiently large. Therefore, it is important to consider these transient forces. A fast-acting force can often be more detrimental to a structure than one that is more dispersed with respect to time.

Geometry plays a critical role in the response of a structure to a dynamic load. The four spiral geometries included in this invention disclosure comprise a cylindrical bar, a tapered cylindrical bar, a spiral with a cylindrical cross-section, and a tapered spiral with a cylindrical cross-section. The cylindrical bar serves as a ‘base-line’ case. By comparing the response of the tapered cylinder to that of the uniform cylinder, we gain insight into how reducing the cross-sectional area influences the transient response of the structure. Similarly, comparison of the spiral geometry to the uniform cylinder leads to an understanding of the effects of increasing curvature on the wave propagation. Finally, analysis of the tapered spiral allows us to understand the coupled influence of increasing curvature and decreasing cross-sectional area on wave propagation and reflection.

The suture is also a geometric effect that plays a critical role in structures under dynamic loads. The suture is compared to a baseline embedded straight line showing the much greater dissipation by way of lower pressures and lower impulses.

With the exception of the simple cylinder, obtaining exact solutions for these geometries is unpractical, if not impossible. Furthermore, the main goal of the analysis behind the present invention was to provide more of a qualitative understanding of how the transients are affected by only geometric differences. For these reasons, a purely computational approach employing the finite element (FE) method was chosen to study the wave propagation and reflection characteristics of these bodies. The FE method is the most efficient technique to perform these types of studies and has become a widely accepted analysis tool. See, for example, Demma A, Cawley P, Lowe M, Pavlakovic B., “The effect of bends on the propagation of guided waves in pipes,” Journal of Pressure Vessel Technology, Transactions of the ASME 2005; 127:328; Gavric L., “Computation of Propagative Waves in Free Rail Using a Finite Element Technique,” Journal of Sound and Vibration 1995; 185:531; Treyssède F., “Elastic Waves in Helical Waveguides,” Wave Motion 2008; 45:457; Mace B R, Duhamel D, Brennan M J, Hinke L., “Finite Element Prediction of Wave Motion in Structural Waveguides,” Journal of the Acoustical Society of America 2005; 117:2835; and “ABAQUS v6.10 User Documentation,” Providence, R.I.: Dassault Systemes Simulia Corp., 2010, all of the foregoing of which are incorporated herein by reference.

### 1. Methodology

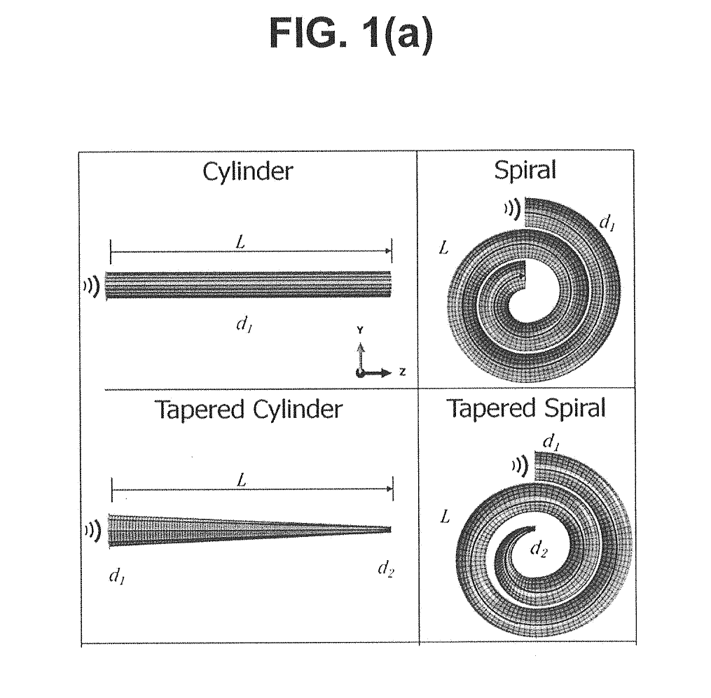

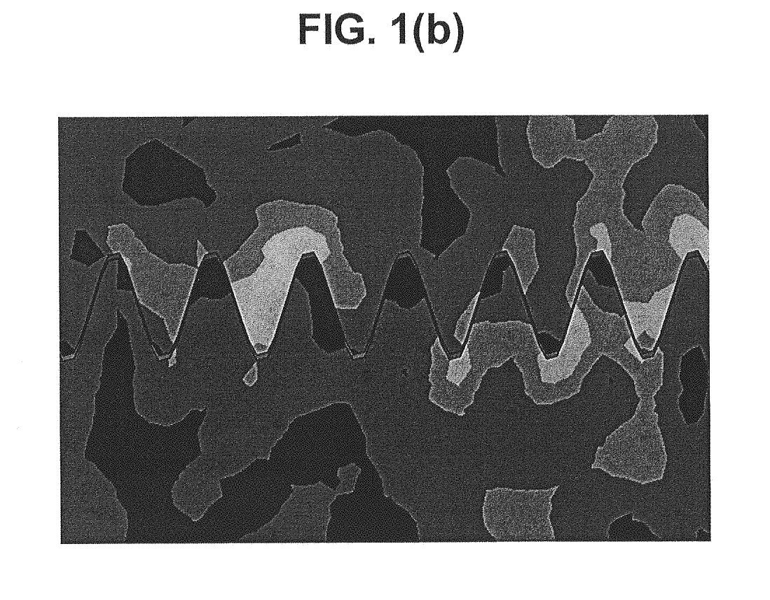

FIG. 1(a) depicts the four geometries that were studied along with the load and boundary conditions that were prescribed. The length and cross-sectional dimensions of each model were kept consistent. The actual dimensions used in the finite element analysis are provided in Table 1.

The ratio of total length to cross-sectional diameter was also maintained among the four geometries; i.e., L/d₁=10. The ratio of the large and small-end diameters was also consistent; d₁/d₂=2 for the tapered geometries.

TABLE 1
Actual dimensions of each geometry used in finite element analysis.

| | Total | Fixed-end | Free-end | Fixed-end | Free-end |
|---|---|---|---|---|---|
| | Length, L | Diameter, | Diameter, | Area, A₁ | Area, A₂ |
| Geometry | (×10⁻¹ m) | d₁(×10⁻² m) | d₂ (×10⁻² m) | (×10⁻³ m²) | (×10⁻³ m²) |
| Cylinder | 7.04 | 7.04 | 7.04 | 3.89 | 3.89 |
| Tapered Cylinder | 7.04 | 7.04 | 3.52 | 3.89 | 0.97 |
| Spiral | 7.04 | 7.04 | 7.04 | 3.89 | 3.89 |
| Tapered Spiral | 7.04 | 7.04 | 3.52 | 3.89 | 0.97 |

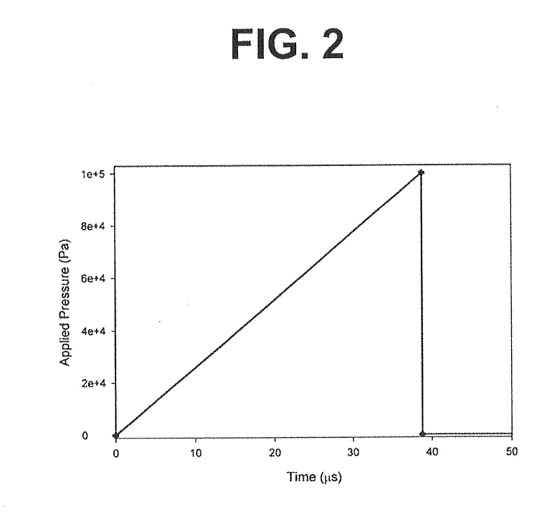

The finite element program ABAQUS/Explicit v6.10 [10] was used as the numerical model in the study for all simulations. It is anticipated that any finite element code would give similar results to all of the solutions generated here. Linear elastic material properties typical of steel were used; i.e. mass density, Poisson's ratio, v=0.3, and Young's modulus, E=207 GPa. All geometries were meshed with 3-dimensional, 8-noded, continuum, linear, brick elements with reduced integration and hourglass control (C3D8R). A ramped, compressive, pressure pulse was applied to the end of each bar. The peak amplitude and duration were set as 1×10⁵ Pa and 38.8 μs, respectively. The prescribed load history is shown in FIG. 2. The nodes along the outer perimeter of the load-end were pinned (u₁=u₂=u₃=0) for each case. No additional constraints were prescribed. The resulting stress wave was allowed to propagate through the structure for 800 μs prior to terminating the calculation.

Post-processing of data was performed using ABAQUS/CAE v6.10 [10]. Wave propagation plots were generated by defining a path through each model that extended from the cross-sectional center of the fixed end (or attached end or mounted end) to the cross-sectional center of the free end (or unattached end or unmounted end). Pressure and displacement response histories at the free-ends were generated by averaging the respective output of each node lying on the cross-section of the free end.

FIG. 1(b) shows the wave dispersion of the pressure once a wave was initiated at the left end of the block. There is a gap between the upper and lower material in a wave form.

### 2. Results

The speed at which a longitudinal, elastic wave travels through a cylindrical, isotropic bar is given by c_{L}=\sqrt{E/ρ}, where E and ρ are the Young's modulus and mass density, respectively. Similarly, an elastic, shear wave travels through the same media at a speed given by c_{S}=\sqrt{G/ρ} where the shear modulus,

$$G = \frac{E}{2 ( 1 - v )} .$$

Substitution of the typical steel values given above yields c_{L}=5.152×10³ m/s and c_{S}=3.196×10³ m/s.

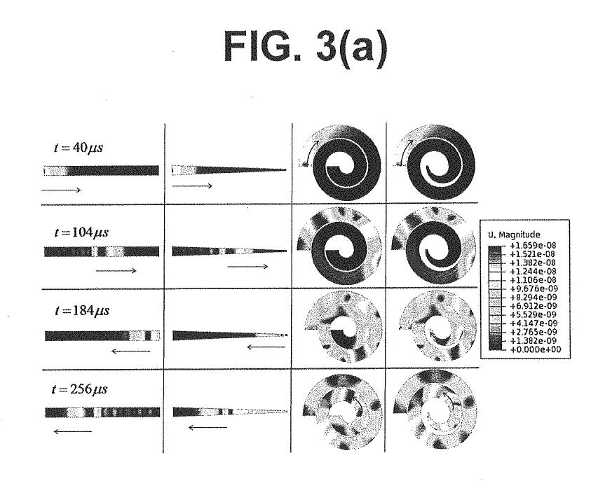

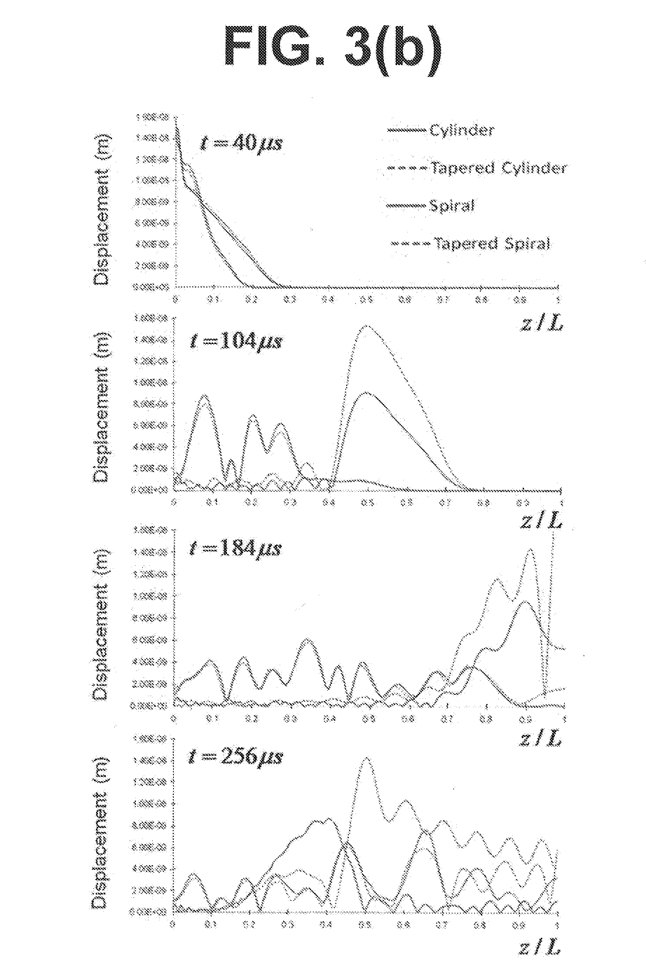

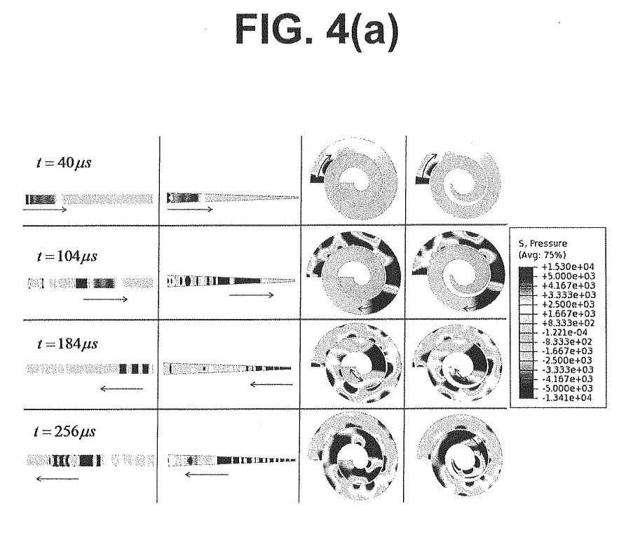

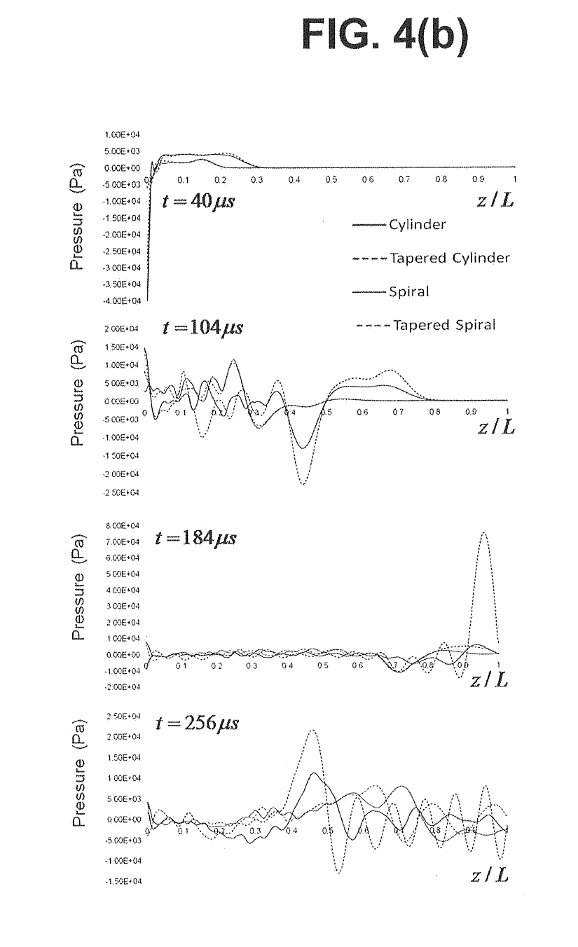

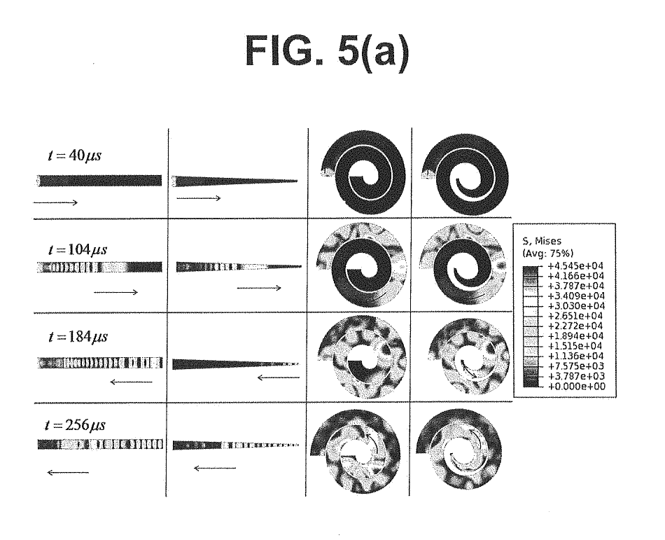

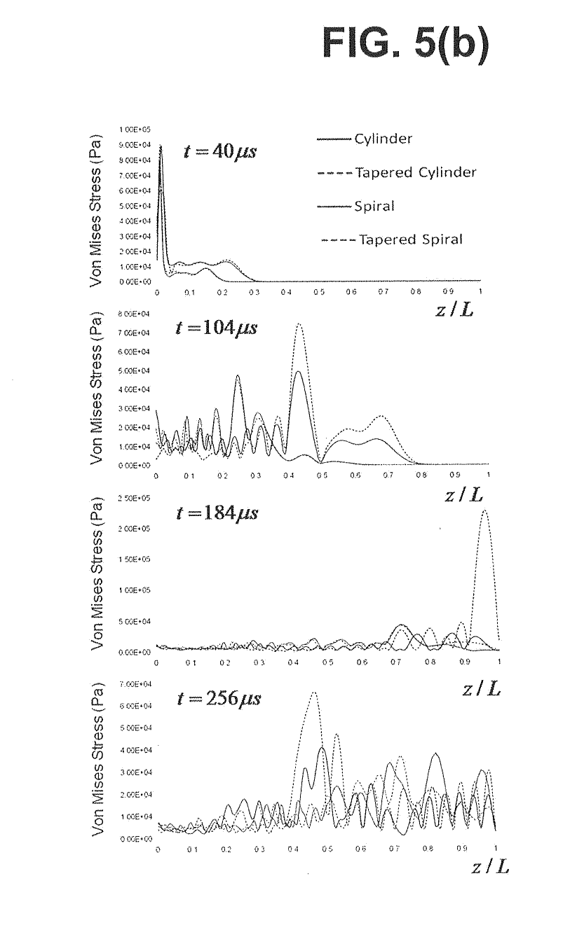

Displacement contour and wave propagation plots for the cylinder, tapered cylinder, spiral, and tapered spiral are shown in FIG. 3. The plots for t=40 μs show the initial wave immediately after the pressure load is released. At t=104 μs, the wave is traveling in the +Z direction. The wave reaches the free end of the tapered cylinder at t=184 μs. At t=256 μs, the reflected wave is traveling in the −Z direction on its way back to the fixed end. And at t=328 μs, the wave peak reaches the fixed end of the cylinder where it had originated. Similar plots for pressure and the von Mises stress invariants are provided in FIG. 4 and FIG. 5, respectively.

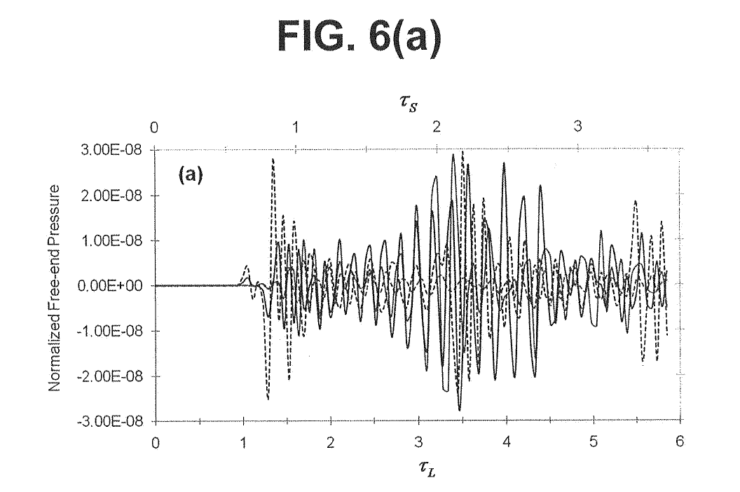

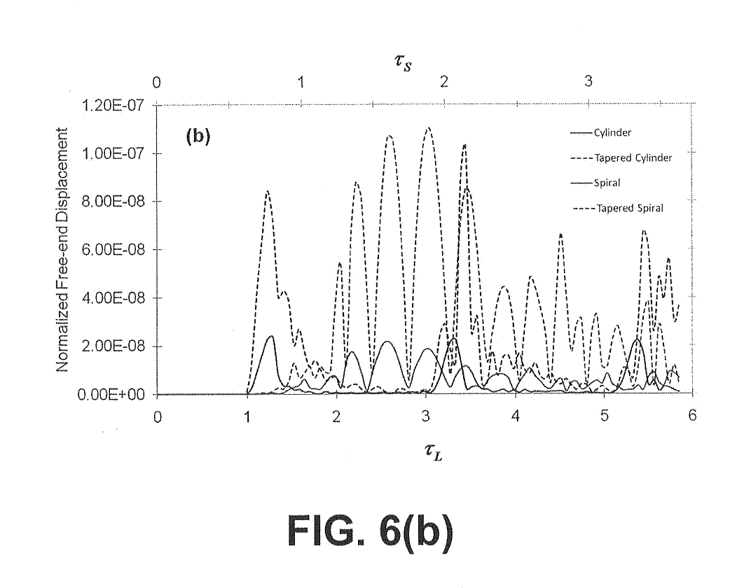

FIG. 6(a) shows the pressure response at the free end of the cylinder, tapered cylinder, spiral, and tapered spiral. The free-end displacement response for the four geometries is shown in FIG. 6(b). On the lower abscissa, τ_{L}=t·(c_{L}/L)=1 is the time at which the longitudinal wave first reaches the free end. The first and second reflected longitudinal wave arrive back at the free end at τ_{L}=3 and τ_{L}=5, respectively. Similarly, on the upper abscissa, τ_{S}=t·(c_{S}/L)=1 corresponds to the time at which the shear wave reaches the free end and τ_{S}=3 represents the arrival of the reflected wave back to the free end.

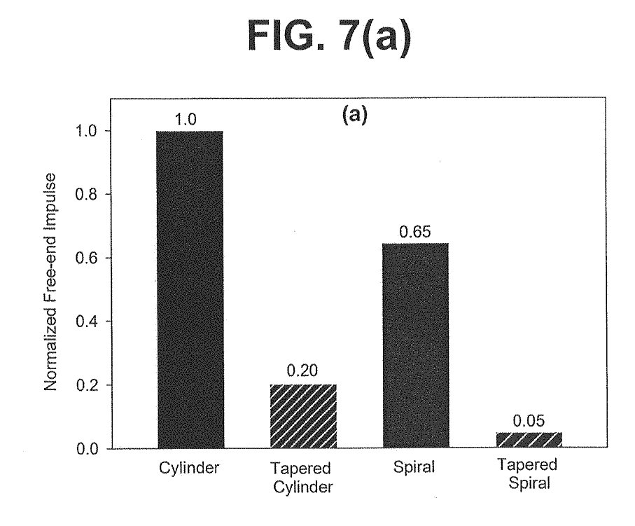

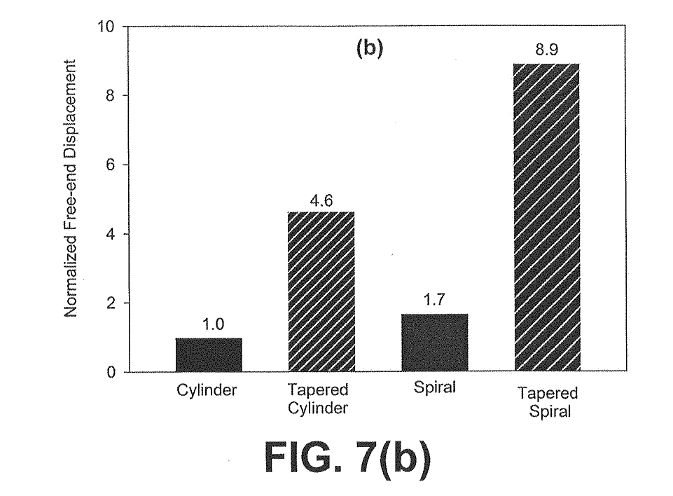

FIG. 7(a) compares the normalized impulse at the free end. The impulse is calculated by multiplication of the free-end pressure history by the respective free-end area followed by integration of the resulting force history (where negative values are neglected). FIG. 7(b) is a comparison of the normalized free-end displacement. Free-end displacement is taken as the area under the free-end displacement history curve. The free-end impulse and displacement values of the cylinder are used to normalize the results and provide simple comparison.

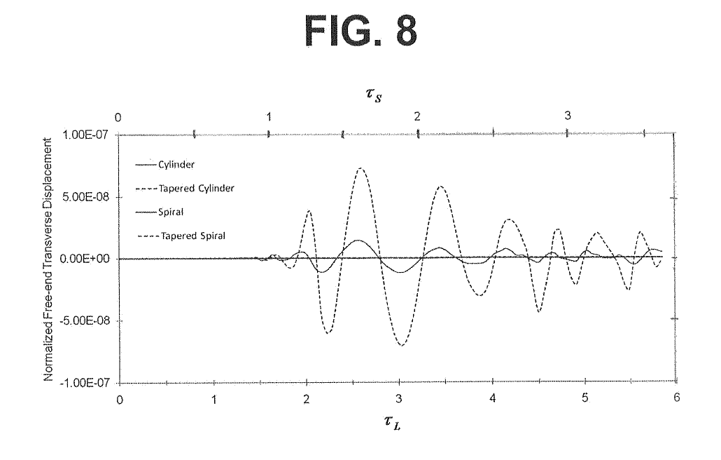

FIG. 8 shows the transverse displacement response.

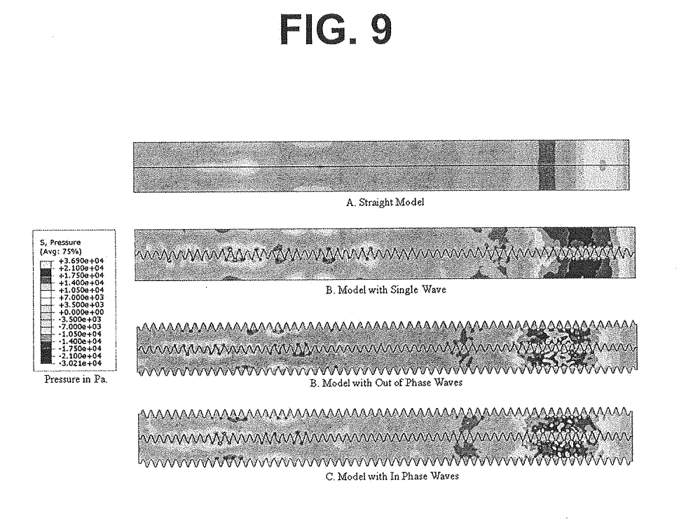

FIG. 9 shows the different scenarios of the suture within the block of material representing a simple structure. It is anticipated that any structural geometry with the suture would generate similar results. The different colors illustrate the effect of the reflections of the various boundaries along with the suture.

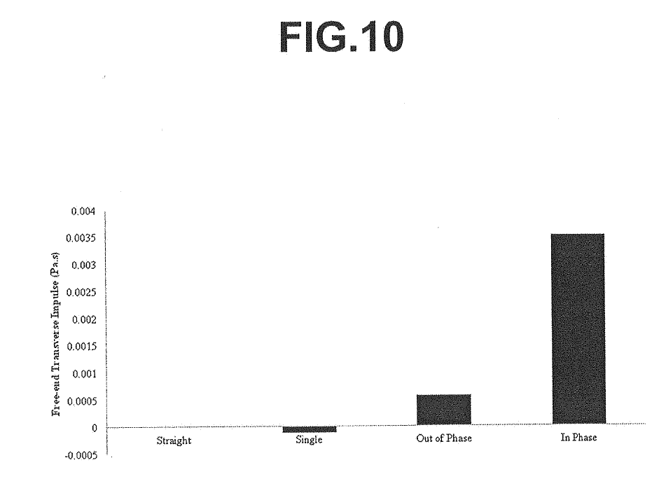

FIG. 10 shows the dramatic drop in the impulse when the embedded wave was introduced with a single wave, a single wave with an out-of-phase wavy boundary, and a single wave with an in-phase wavy boundary. Clearly, the interactions of the embedded wavy geometries reduce dramatically the impulses (integrated pressure-time histories) much more than the straight line baseline case.

### 3. Analysis and Discussion

From FIG. 3, we see that at t=40 μs, the wave front is at z/L=0.3 for the cylinder and tapered cylinder. Comparing that to the position of the wave at r=104 μs, we see that, prior to any reflection from the free end, the wave travels through the cylinder and tapered cylinder at approximately the same velocity. However, the displacement amplitude is magnified by the reduction in area of the tapered cylinder. The displacement wave reaches the free end of the tapered cylinder at t=184 s. At this same time, the wave has already reflected from the free end of the uniform cylinder and is traveling in the −Z direction.

In the two spiral geometries, there is a slight bump in the displacement at t=104 μs and z/L=0.5, but the main displacement wave in the spiral geometries lags behind the main wave in the cylinders. Also, in the spirals, there are more wave interactions as the waves reflect off the surfaces, which cause the waves to be more dispersed.

The displacement wave reaches the free end of the tapered cylinder first, at t=184 μs. At t=256 μs, the cylinder leads the tapered cylinder. The reflected wave in the tapered cylinder travels slower.

The shear wave travels slower than the longitudinal wave. Therefore, when the waves arrive at the boundary at different times, this leads to dispersion and/or cancellation and lower impulse near the free end of the rods. For the spirals t=184 μs is an interesting time because the longitudinal wave has reached the free end but the shear wave has not.

Pressure (or hydrostatic stress), as plotted in FIG. 4, is the stress that tends to change the volume of the body. Compressive stress is taken as positive and tensile stress is negative. The von Mises stress that is used to construct FIG. 5 is the second deviatoric stress invariant, i.e., the von Mises stress is the part of stress tensor that tends to distort the body and is independent of the hydrostatic stress component.

### 4. Conclusions Based Upon Experimental Data

The spiral shaped element and the suture are two useful ways in dissipating energy imposed upon it by an object. In general, the suture can be (a) a wavy gap in a material or material layer, (b) a wavy gap in a first material or material layer with a second material situated therein, or (c) a wavy interface between two or more parts of a material. The energy is dissipated as a shear wave by vibration of the spiral shaped element and/or the suture. Furthermore, the tapered spiral shaped element is better at dissipating impact energy than the spiral shaped element having uniform circular cross section throughout its length. Also, when multiple sutures are introduced within a material, more dissipation occurs as well.

The impact can occur from any direction (and any angle), and the spiral shaped element and/or suture will dissipate the impact energy.

The spiral shaped elements and the suture can be made out of numerous possible materials. Any material that will enable vibration can be used including, but not limited to, elastic, viscoelastic, plastic, etc.

Shock mitigating materials can be manufactured to include one or more of the spiral shaped elements or sutures. For example in the case of a helmet, such as a football helmet, a helmet layer or football helmet pad insert can be produced with one or more, but preferably numerous, spiral shaped elements in order to dissipate energy when a football player wearing the helmet is impacted. The outer shell of the helmet can also be further supplemented to have embedded wavy materials or gaps included in the design to help further dissipate impact energy by transforming the impact energy into shear waves.

An example of a shock mitigating material with spiral shaped elements used in a helmet is shown and described in commonly assigned U.S. patent application Ser. No. 14/694,715, filed Apr. 23, 2015, which is incorporated herein by reference. FIGS. 1 and 2A of the application illustrate the spiral elements 223. Further, the invention includes embodiments comprising a manufactured shock-mitigating material comprising a layer having a body with a first surface, a second surface, and a periphery of edges, as well as a plurality of spiral shaped elements, each of which is capable of transforming a substantial part of a longitudinal mechanical shock wave imposed upon it into shear waves within the material layer when the material layer is impacted by an object in order to dissipate impact energy and action associated with the shock wave.

In the shock mitigating materials, the spiral shaped elements can be situated in or surrounded by air, liquids, gel, elastic, viscoelastic, plastic, or any other material that permits the spiral shaped element to vibrate for the purpose of dissipating impact energy. Furthermore the suture can include air, liquids, gels, viscoelastic, plastic, or any other material that admits the wave to dissipate.

### 5. Helmet with Spiral Elements and/or Sutures

The helmet in some embodiments comprises a shell that has a first portion and a second portion. The first portion of the shell may include a core layer that is surrounded by layers that are denser than the core layer. For example, the core layer may be constructed of a foam, and the surrounding layers may be constructed of a para-aramid synthetic fiber, such as a KEVLAR fiber, fixed in a matrix. Because the core layer is less dense than the surrounding layers, the first portion of the shell may mitigate shock waves that are imparted to the helmet.

Furthermore, in some embodiments, a suture or sutures (i.e., at least one suture) may be formed in one of the layers that surrounds the core layer. An elastomeric adhesive may be disposed in the suture(s) to hold portions of the layer together. The suture(s) and elastomeric adhesive may also mitigate shock waves that are imparted to the helmet.

In addition, the second portion of the shell may include multiple energy dissipaters, such as elastomeric tapered spirals. The energy dissipaters may be configured to dissipate energy imparted to the helmet. In particular, the energy dissipaters may dissipate energy through shear action in the energy dissipaters.

Various embodiments of the helmets described herein may mitigate shock waves, trap momentum, and dissipate energy so that the risk of wearers experiencing injuries, such as MTBI and CTE, are reduced. In the following discussion, a general description of the system and its components is provided, followed by a discussion of the operation of the same.

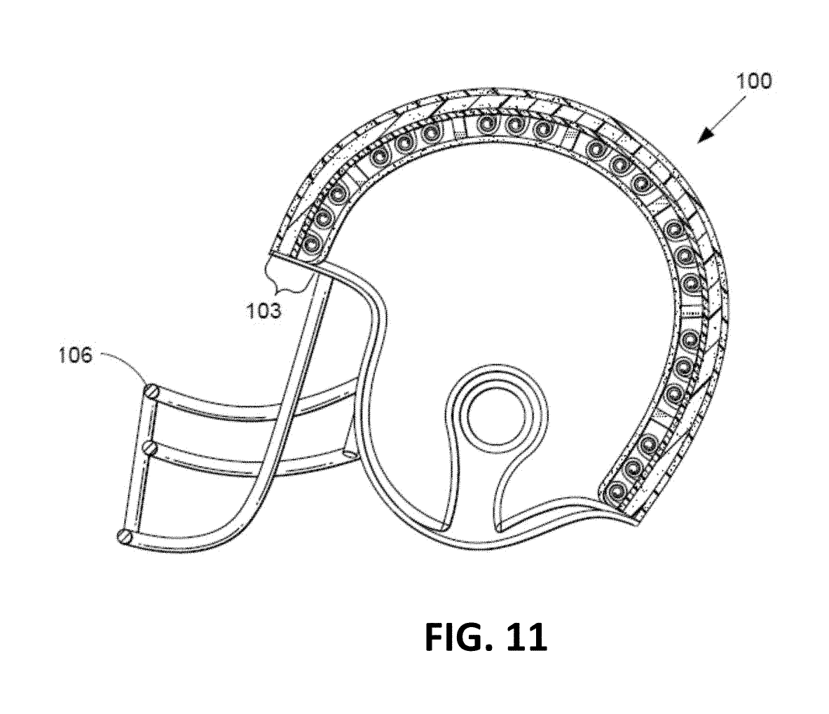

With reference to FIG. 11, shown is a cross-section of an example of a football helmet 100 according to various embodiments. In alternative embodiments, the helmet 100 may be embodied in the form of other types of athletic helmets, such as hockey helmets, lacrosse helmets, etc. Additionally, the helmet 100 in other examples may be embodied in the form of a racing helmet, such as an automotive racing helmet, a motorbike racing helmet, etc. In addition, the helmet 100 in alternative examples may be embodied in the form of a tactical helmet, which may be used, for example, by law enforcement or military personnel.

The helmet 100 may comprise a shell 103, a facemask 106, a liner (not shown), and/or other components. The shell 103 may be the outermost portion of the helmet 100 that surrounds at least a portion of the wear's head. Accordingly, the exterior surface of the shell 103 may contact objects, such as other helmets 100, when in use. The facemask 106 may protect the face of the wearer of the helmet 100.

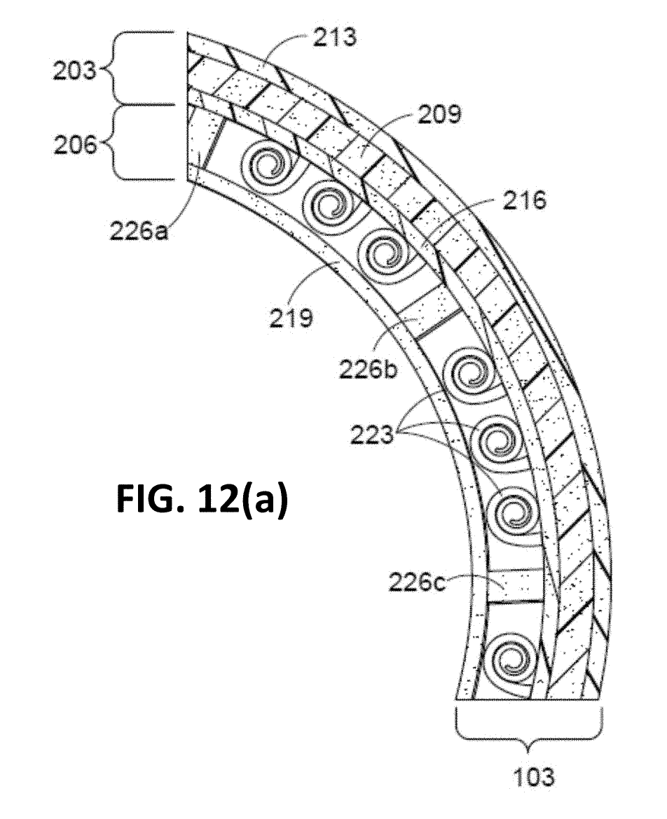

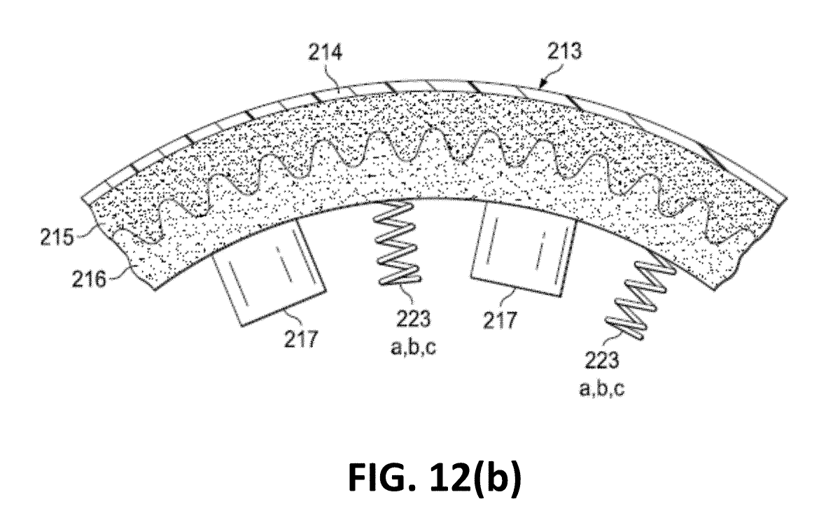

With reference to FIG. 12, shown is a cross-section of a portion of an example of the shell 103 according to various embodiments. The shell 103 illustrated in FIG. 12 is a multilayer shell 103 that comprises a first portion 203 and a second portion 206. For the embodiment shown in FIG. 12, the first portion 203 of the shell 103 is on the exterior side of the shell 103, and the second portion 206 of the shell 103 is on the interior side of the shell 103. However, in alternative embodiments, the first portion 203 of the shell 103 may be on the interior side of the shell 103, and the second portion 206 of the shell 103 may be on the exterior side of the shell 103. Additionally, for the embodiment illustrated in FIG. 12, the first portion 203 of the shell 103 is in direct contact with the second portion 206 of the shell 103. In alternative embodiments, the first portion 203 of the shell 103 may be separated from the second portion 206 of the shell 103.

FIGS. 12(a) and 12(b) show different configurations for the shell. The embodiment illustrated in FIG. 12(a) shows that the first portion 203 of the shell 103 may include a core layer 209 that is positioned between a first surrounding layer 213 and a second surrounding layer 216. The first surrounding layer 213 and the second surrounding layer 216 may comprise a para-aramid synthetic fiber, such as a KEVLAR, carbon, E-glass, or S-Glass fiber, that is fixed in a polymeric matrix. In FIG. 12(b), a layer 214 is added that may be a very hard, slippery layer comprising a thermoset or thermoplastic on the outside of layer 213. Such a matrix for any configuration in FIGS. 12(a) and 12(b) may comprise polypropylene, polyurethane, polycarbonate, and/or any other suitable material. The first surrounding layer 213 and the second surrounding layer 216 may be denser and less porous than the core layer 209. FIG. 12(b) also includes layer 215, which comprises a wavy suture material made of a nonlinear, highly deforming elastic material, viscoelastic material, and/or viscoplastic material. Layer 216 comprises a polymeric thermoplastic or thermoset that is highly ductile that can be, but is not limited to, a polycarbonate, sorbothane, etc.

For the configuration illustrated in FIG. 12(a), the core layer 209 may comprise a foam. For example, the core layer 209 in one embodiment comprises a polymeric foam that can be, but is not limited to, a SUNMATE foam. The core layer 209 may be less dense and more porous than both the first surrounding layer 213 and the second surrounding layer 216. Accordingly, the first portion 203 of the shell 103 may be functionally graded. For the configuration illustrated in FIG. 12(b), layer 217 can be a closed or open cell polymeric foam that can be used for energy absorption. This foam material can be, but is not limited to, a SUNMATE foam.

The second portion 206 of the shell 103 may include a side layer 219, a plurality of energy dissipaters 223, and a plurality of support columns 226a-226c. In some embodiments, the side layer 219 may comprise a para-aramid synthetic fiber, such as a KEVLAR, carbon, E-glass, or S-glass fiber, fixed in a matrix, such as a polypropylene, polyurethane, polycarbonate, and/or any other suitable matrix.

The support columns 226a-226c may attach the side layer 219 to the first portion 203 of the shell 103. For the embodiments illustrated in FIGS. 12(a) and 12(b), the support columns 226a-226c attach to both the side layer 219 and the second surrounding layer 213. In addition, the support columns 226a-226c may position the side layer 219 so that the side layer 219 does not contact the energy dissipaters 223. In some embodiments, the support columns 226a-226c comprise a polycarbonate.

The energy dissipaters 223 are configured to dissipate energy that is imparted to the helmet 100. In some embodiments, an energy dissipater 223 may dissipate energy by a shearing action in the energy dissipater 223. Examples of energy dissipaters 223 are described in further detail below. In some embodiments, the energy dissipaters 223 may be arranged in rows throughout at least a portion of the shell 103, as illustrated in FIGS. 12(a) and 12(b).

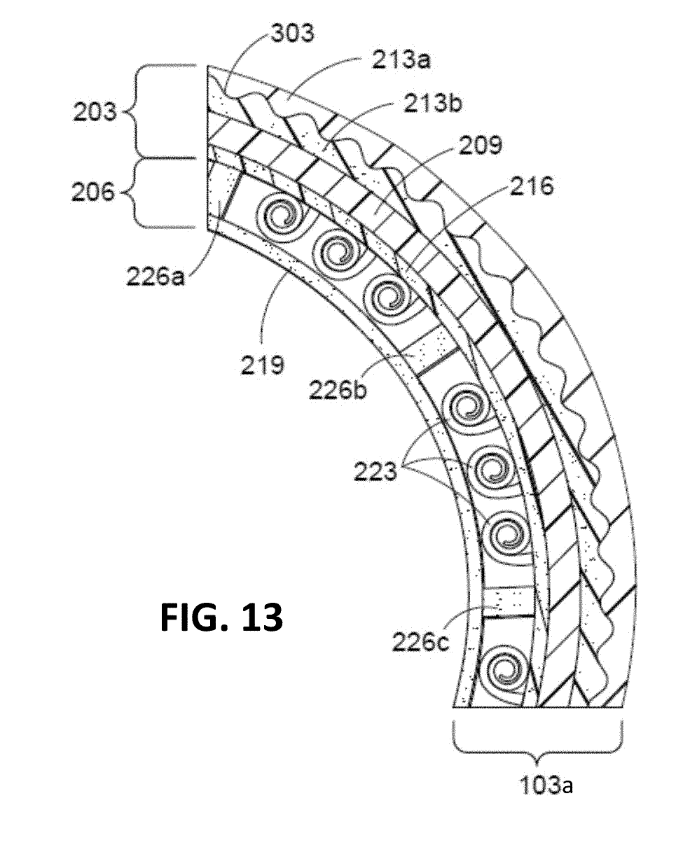

With reference to FIG. 13, shown is a cross-section of a portion of another example of the shell 103, referred to herein as the shell 103a, according to various embodiments. The shell 103a has some features that are similar to the shell 103 illustrated in FIG. 12. However, the first surrounding layer 213 of the first portion 203 of the shell 103 is segmented into a first surrounding layer portion 213a and a second surrounding layer portion 213b.

In particular, a suture 303 may exist between the first surrounding layer portion 213a and the second surrounding layer portion 213b. The suture 303 may be regarded as being a relatively rigid joint between the first surrounding layer portion 213a and the second surrounding layer portion 213b. In some embodiments, the suture 303 may extend around the entire shell 103. In other embodiments, the suture 303 may extend around only a portion of the shell 103. The suture 303 may comprise an elastomeric adhesive. In addition to attaching the first surrounding layer portion 213a to the second surrounding layer portion 213b, the elastomeric adhesive may facilitate shear deformation in the first surrounding layer 213 when the helmet 100 is subjected to an impact.

The suture 303 may have a sinusoidal shape that is curved to conform to the shape of the shell 103. In these embodiments, the ratio of the amplitude to the wavelength may be within the range from about 0.25 to about 2.0.

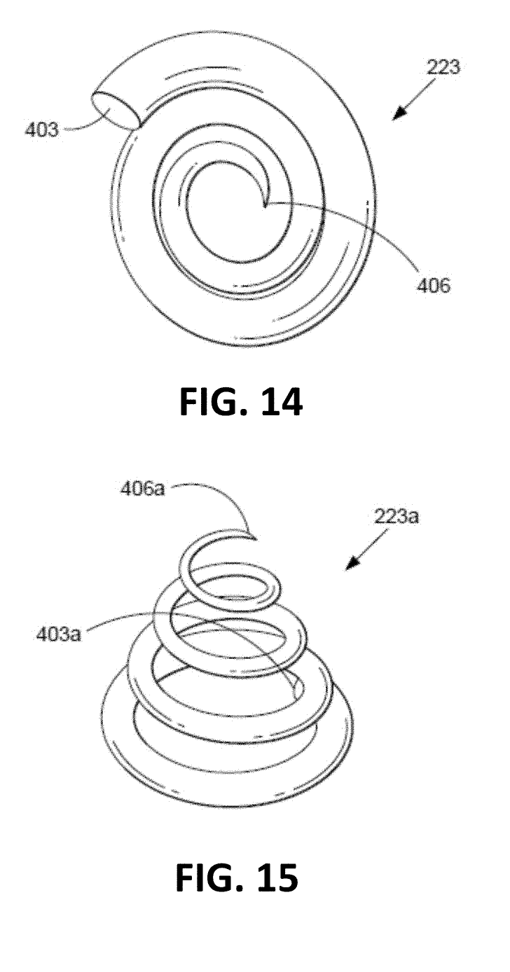

With reference to FIG. 14, shown is an example of a tapered spiral shaped element 223. The spiral shaped element 223 is in a planar configuration, i.e., a spiral in a single plane. The spiral shaped element 223 illustrated in FIG. 14 comprises a tapered spiral structure. In particular, the spiral shaped element 223 shown comprises a base 403 and a tip 406 that has a diameter less than the diameter of the tip 406. In some embodiments, the ratio of the diameter of the tip 406 to the diameter of the base 403 may be within the range from about 0.1 to about 0.9. Additionally, the ratio of the diameter of the base 403 to the spiral length may be from about 0.01 to about 1.0.

The base 403 of the spiral shaped element 223 may be attached directly to the second surrounding layer 216 of the first portion 203 of the shell 103. When the helmet 100 is subjected to an impact, energy may be transferred to the spiral shaped element 223 and dissipated through shear action in the spiral shaped element 223.

With reference to FIG. 15, shown is another example of a spiral shaped element 223, referred to herein as the spiral shaped element 223a. The spiral shaped element 223a is a tapered conic helix structure. In this regard, the spiral shaped element 223a forms a conic helix, and the diameter of the spiral shaped element 223a tapers as the length progresses from the base 403a to the tip 406a.

The base 403a of the spiral shaped element 223a may be attached directly to the second surrounding layer 216 of the first portion 203 of the shell 103. When the helmet 100 is subjected to an impact, impact energy is transferred to the spiral shaped element 223a and dissipated through shear action in the spiral shaped element 223a.

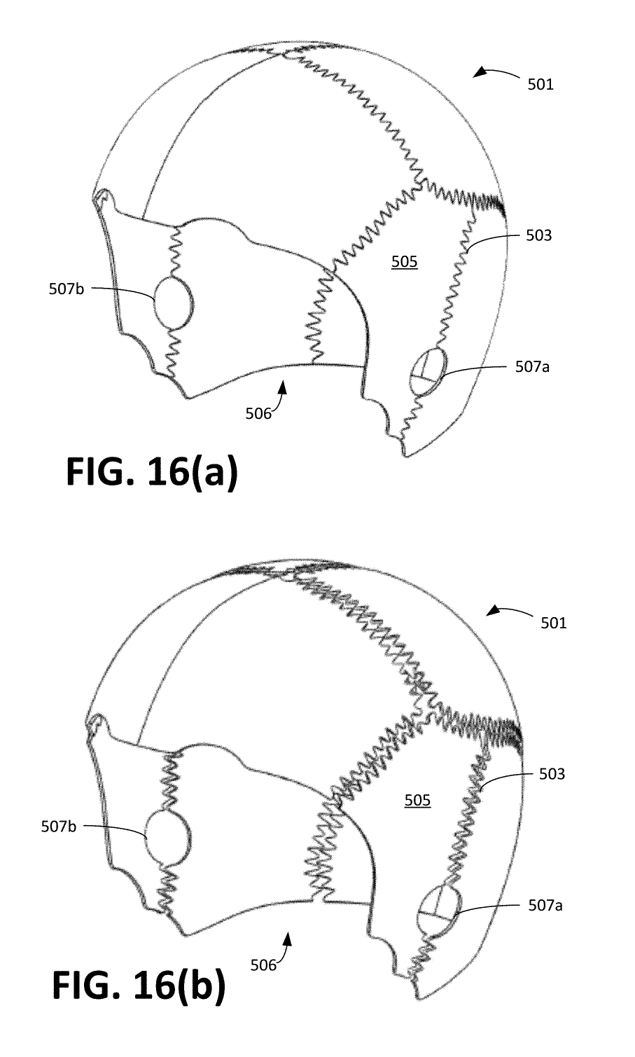

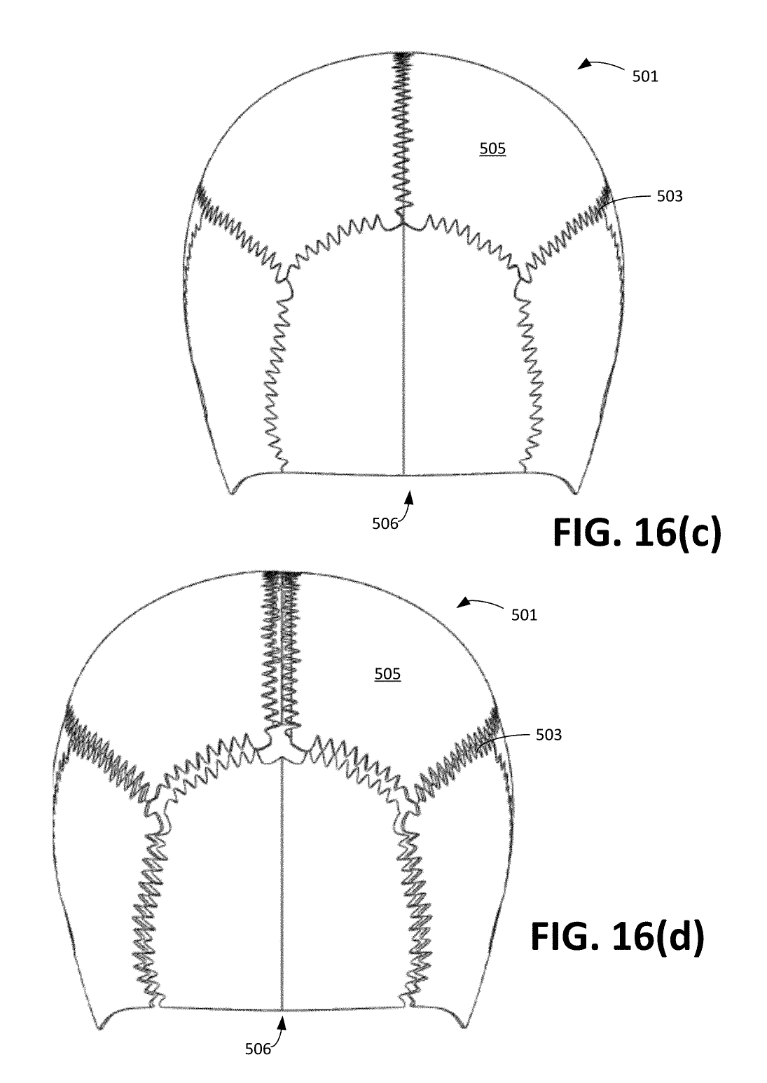

FIGS. 16(a) through 16(d) are views of an embodiment of a material layer 501 for a helmet wherein the material layer 501 has a plurality of sutures 503, denoted by reference numeral 503. The material layer 501 has an opening 506 with sufficient size and shape to receive the head of a human and includes ear holes 507a and 507b. In this example, the material layer 501 has 8 sections 505 that are separated by the sutures 503. The sutures 503 may comprise a wavy interface between different sections of the material layer 501 or a wavy gap with or without a material within the gap.

### 6. Variations, Modifications, and Other Embodiments

It should be emphasized that the above-described embodiments of the present invention, particularly any “preferred” embodiments, are merely possible examples of implementations that are set forth for a clear understanding of the principles of the invention. Many variations and modifications may be made to the above-described embodiment(s) of the invention without departing substantially from the spirit and principles of the invention. All such variations and modifications are intended to be included herein within the scope of the disclosure of the present invention. References to ‘a’ or ‘an’ concerning any particular item, component, material, structure, or product is defined as at least one and could be more than one.

The spiral shaped elements in the shock mitigating material can take many different shapes and sizes, depending upon design and/or manufacturing preferences. Also, the suture(s) can also take different wave forms (sinusoid, blocks, triangles, etc.) with different amplitudes and periods.

In some embodiments of shock mitigating materials, each spiral shaped element has a consistently-shaped cross section (e.g., circular, polygonal, triangular, square, rectangular, trapezoidal, etc.) throughout its length and is tapered either from a large outside end to a small inside end or from a small outside end to a large inside end. The amplitude and the period of the embedded wavy material may also change within the structure.

In other embodiments of shock mitigating materials, each of the spiral shaped elements is configured in the shape of a helix (or corkscrew). Moreover, the helix in this configuration may be tapered or non-tapered. Finally, each element can be in the shape of a conical helix, conical toroid, cylinder helix, or other helix. The suture may also have three dimensional helical attributes as well.

In other embodiments of shock mitigating materials, each of the spiral shaped elements reside (are coiled) in a single plane. The elements can be placed side by side in the materials.

In other embodiments of shock mitigating materials, each of the spiral shaped elements is a sheet that is disposed in a rolled configuration so that its cross section along the span of the elongate structure is spiral. The sheet can be tapered or non-tapered from an outside end to an inside end. Furthermore, each of the elements can be non-uniform along the elongated span of the rolled configuration; for example, it could be conical.

In other embodiments of shock mitigating materials, there exists a mix of different types of spiral shaped elements, as previously mentioned.

At least the following is claimed:

1. A manufactured, shock-mitigating material, the material comprising:
a plurality of spiral shaped elements, each of the spiral shaped elements having a cantilevered rod that extends in a spiraling manner from a first end to a second end, the rod tapering continuously along its length from the first end to the second end so that the first end exhibits a larger internal cross sectional area than the second end, the first end being fixed and the second end being unfixed and free, the second end capable of movement and vibration when the material is impacted by an object; and
wherein each of the spiral shaped elements is capable of transforming a substantial part, if not all, of a longitudinal mechanical shock wave imposed upon it into shear waves within the material layer when the material layer is impacted by the object in order to dissipate impact energy and action associated with the shock wave.

2. The material of claim 1, wherein the internal cross sectional area of the rod associated with each of the spiral shaped elements is circular.

3. The material of claim 1, wherein the internal cross sectional area of the rod associated with each of the spiral shaped elements is polygonal.

4. The material of claim 1, wherein at least one of the spiral shaped elements forms a helix.

5. The material of claim 1, wherein at least one of the spiral shaped elements forms a spiral in a single plane.

6. The material of claim 1, wherein at least one of the spiral shaped elements forms a sheet that is disposed in a rolled spiral configuration.

7. The material of claim 1, wherein the spiral shaped elements are situated in or surrounded by a material that permits the free end of the spiral shaped elements to vibrate to enable dissipation of the impact energy.

8. The material of claim 1, wherein the spiral shaped elements are made from a polymer.

9. A manufactured, shock-mitigating material, the material comprising:
a plurality of spiral shaped elements, each of the spiral shaped elements having a rod that extends in a spiraling manner from a first end to a second end, the rod tapering continuously along its length from the first end to the second end so that the first end exhibits a larger internal cross sectional area than the second end, the first end being fixed and the second end being unfixed and free, the second end capable of movement and vibration when the material is impacted by an object; and
wherein each of the spiral shaped elements is capable of transforming a substantial part of a longitudinal mechanical shock wave imposed upon it into shear waves within the material layer when the material layer is impacted by the object in order to dissipate impact energy and action associated with the shock wave.

10. The material of claim 9, further comprising first and second layers, wherein the second layer includes the plurality of spiral shaped elements with their respective free ends situated in air, and wherein the respective fixed ends of the spiral shaped elements are attached to the first layer.

11. A manufactured, shock-mitigating material, the material comprising:
a layer having a body with a first surface, a second surface, and a periphery of edges;
a plurality of spiral shaped elements, each of the spiral shaped elements having a cantilevered rod that extends in a spiraling manner from a first end to a second end, the rod tapering continuously along its length from the first end to the second end so that the first end exhibits a larger internal cross sectional area than the second end, the first end being attached to the layer of the material, the second end being unattached, the second end capable of movement and vibration when the material is impacted by an object; and
wherein each of the spiral shaped elements is capable of transforming a substantial part of a longitudinal mechanical shock wave imposed upon it into shear waves within the material layer when the material layer is impacted by the object in order to dissipate impact energy and action associated with the shock wave.

12. The material of claim 11, wherein the plurality of spiral shaped elements are situated in an adjacent layer that is adjacent to the layer.

13. The material of claim 11, wherein the internal cross sectional area of the rod associated with each of the spiral shaped elements is circular.

14. The material of claim 11, wherein the internal cross sectional area of the rod associated with each of the spiral shaped elements is polygonal.

15. The material of claim 11, wherein at least one of the spiral shaped elements forms a helix.

16. The material of claim 11, wherein at least one of the spiral shaped elements forms a spiral in a single plane.

17. The material of claim 11, wherein at least one of the spiral shaped elements forms a sheet that is disposed in a rolled spiral configuration.

18. The material of claim 10, wherein the spiral shaped elements are situated in or surrounded by air that permits the free end of the spiral shaped elements to vibrate to enable dissipation of the impact energy.

19. The material of claim 10, wherein the spiral shaped elements are made from a polymer.
